(19) United States
(12) Patent Application Publication
(10) Pub. No.: US 2017/0236610 A1
(43) Pub. Date: Aug. 17, 2017

(54) Method for Enhancing Adhesion of Silver Nanoparticle Inks Using a Functionalized Alkoxysilane Additive and Primer Layer

(71) Applicant: Tyco Electronics Corporation, Berwyn, PA (US)

(72) Inventors: Yiliang Wu, San Ramon, CA (US); Barry C. Mathews, Fremont, CA (US); Miguel A. Morales, Fremont, CA (US); Leonard Henry Radzilowski, Palo Alto, CA (US); Michael A. Oar, San Francisco, CA (US); Ranjan Deepak Deshmukh, Mechanicsburg, PA (US); James Paul Scholz, Mechanicsburg, PA (US); Bruce Foster Bishop, Aptos, CA (US); Jerry L. Moore, Mechanicsburg, PA (US)

(73) Assignee: Tyco Electronics Corporation, Berwyn, PA (US)

(21) Appl. No.: 15/043,468

(22) Filed: Feb. 12, 2016

(51) Int. Cl. H01B 1/02; C09D 11/037; H01B 13/00; C09D 11/52

(52) U.S. Cl. CPC H01B 1/02; C09D 11/52; C09D 11/037; H01B 13/0026

(57) ABSTRACT

An alkoxysilane comprising a functional group is used as an additive in the silver nanoparticle ink, and as an adhesion promoter (or primer layer) on the surface of the substrate in order to enhance the adhesion of silver nanoparticle inks on temperature-sensitive plastic substrates. The combination of the functionalized alkoxysilane both in the ink and on the substrate's surface provides enhanced adhesion after annealing the ink at a low temperature. The adhesion of the annealed films improves from a 0B-3B level to 4B-5B when tested according to ASTM D3359. No degradation of adhesion and no change of color are observed after aging the annealed films in a humidity chamber.

### FIELD

The present disclosure relates to silver nanoparticle ink compositions and the use thereof. More specifically, this disclosure relates to electronic components that include silver nanoparticle inks applied on to a plastic substrate and methods of enhancing adhesion thereto.

### BACKGROUND

The statements in this section merely provide background information related to the present disclosure and may not constitute prior art.

Conductive inks are increasingly being used to form printed elements, such as antennas or sensors, in a variety of 2-D and 3-D electronic applications. However, the adhesion of conductive inks to plastic substrate materials, such as low-cost polycarbonate, is relatively poor and can limit the useful life associated with the printed elements.

Generally, two types of conductive inks are being utilized, namely, polymer thick film (PTF) pastes and metal nanoparticle inks. The PTF pastes are often composed of micron-size metal flakes dispersed in polymer binders. The use of polymer binders allows the cured PTF pastes to adhere to various substrate materials. However, these polymer binders also act as an insulator and have an adverse effect on the conductivity exhibited by the printed conductive elements.

In comparison, the metal nanoparticle inks generally include very little to no amount of polymer binders. Thus upon sintering of the nanoparticle inks, a higher level of conductivity is often obtained. However, this increase in conductivity is obtained at the expense of adhesion to the substrate material.

The use of plastic substrate materials reduces the sintering temperature that can be utilized to cure the conductive inks. The use of low-cost, temperature sensitive plastic substrates requires the conductive ink to exhibit good adherence of the ink to the substrate along with retaining high conductivity (e.g., low resistivity) upon exposure to a low annealing or sintering temperature.

### SUMMARY

The present disclosure generally provides a method of forming a conductive trace on a substrate. The method comprises providing the substrate; applying a primer layer onto a surface of the substrate, wherein the primer layer is formed from starting ingredients containing a first alkoxysilane substance comprising one or more functional groups; at least partially curing the primer layer; providing a silver nanoparticle ink; incorporating a second alkoxysilane substance comprising one or more functional groups into the silver nanoparticle ink to form a modified ink; applying the modified ink onto the primer layer; and annealing the modified ink to form the conductive trace, such that the conductive trace exhibits a 4B or higher level of adhesion, alternatively, a 5B level of adhesion. When desirable, the conductive trace may exhibit a peel strength greater than about 1.5×10² N/m. The conductive trace may also exhibit 5B adhesion after exposure for at least four days to a high humidity environment with 90% relative humidity and at 60° C.

Each of the one or more functional groups of the alkoxysilane substance used to form the primer layer or incorporated into the silver nanoparticle ink is independently selected to be an amino, epoxy, acrylate, methacrylate, mercapto, or vinyl group. The alkoxysilane substance is incorporated into the silver nanoparticle ink in a concentration from about 0.01 wt. % to about 2.0 wt. % based on the total weight of silver in the silver nanoparticle ink. The modified silver nanoparticle ink has substantially the same viscosity as the original silver nanoparticle ink.

The primer layer may be applied to the substrate using a spin coating, a dip coating, a spray coating, a printing, or a flow coating technique and the modified silver nanoparticle ink can be applied onto the at least partially cured primer layer using an analog or a digital printing method. When desirable, the surface of the substrate may be treated using an atmospheric/air plasma, a flame, an atmospheric chemical plasma, a vacuum chemical plasma, UV, UV-ozone, heat treatment, solvent treatment, mechanical treatment, or a corona charging process prior to the application of the primer layer.

According to one aspect of the present disclosure, the primer layer is at least partially cured at a temperature no greater than 120° C. for a period of time ranging between about 2 minutes to about 60 minutes. The at least partially cured primer layer exhibits an average thickness that is equal to or greater than an average roughness (Ra) value measured for the surface of the substrate. Alternatively, the at least partially cured primer layer exhibits an average thickness that is from about 50 nanometers to about 1 micrometer.

The substrate is a plastic substrate formed from a polycarbonate, an acrylonitrile butadiene styrene (ABS), a polyamide, or a polyester, a polyimide, vinyl polymer, polystyrene, polyether ether ketone (PEEK), polyurethane, epoxy-based polymer, polyethylene ether, polyether imide (PEI), polyolefin, or a polyvinylidene fluoride (PVDF) resin.

The silver nanoparticle ink comprises silver nanoparticles having an average particle diameter in the range of about 2 nanometers to about 800 nanometers. Optionally, one or more of the silver nanoparticles is at least partially encompassed with a hydrophilic coating. The average particle diameter of the silver nanoparticles in the conductive trace after annealing is substantially the same as that in the silver nanoparticle ink.

According to another aspect of the present disclosure, a functional conductive layered composite may comprise the conductive trace formed according to the teachings described above and further defined herein. The functional conductive layered composite may function as an antenna, an electrode of an electronic device, or an interconnect joining two electronic components.

According to yet another aspect of the present disclosure, a method of forming a functional conductive layered composite comprises providing a plastic substrate; applying a primer layer to a surface of the plastic substrate; the primer layer is formed from starting ingredients containing a first alkoxysilane substance comprising one or more functional groups; at least partially curing the primer layer at a temperature no more than 120° C., such that the at least partially cured primer layer exhibits an average thickness that is equal to or greater than an average roughness (Ra) value measured for the surface of the substrate; providing a silver nanoparticle ink; incorporating a second alkoxysilane substance comprising one or more functional groups into the silver nanoparticle ink to form a modified ink in a concentration between about 0.01 wt. % and about 2.0 wt. % based on the total weight of silver in the silver nanoparticle ink; applying the modified ink onto the primer layer using an analog or a digital printing process; annealing the modified ink at a temperature no more than 120° C. to form the conductive trace, such that the conductive trace exhibits a 5B level of adhesion; and incorporating the conductive trace into the functional conductive layered composite. The conductive trace may exhibit 5B adhesion after exposure for at least 4 days to a high humidity environment with 90% relative humidity and a temperature of 60° C.

The substrate used in the layered composite may be a polycarbonate, an acrylonitrile butadiene styrene (ABS), a polyamide, a polyester, a polyimide, vinyl polymer, polystyrene, polyether ether ketone (PEEK), polyurethane, epoxy-based polymer, polyethylene ether, polyether imide (PEI), polyolefin, or a polyvinylidene fluoride (PVDF) substrate. The one or more functional groups in the first and second alkoxysilane may be amino groups, epoxy groups, acrylate groups, methacrylate groups, mercapto groups, vinyl groups, or a mixture thereof. In addition, the silver nanoparticle ink may comprise silver nanoparticles having an average particle diameter in the range of about 2 nanometers to about 800 nanometers. The average particle diameter of the silver nanoparticles in the conductive trace after annealing is substantially the same as that in the silver nanoparticle ink.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a printed silver ink antenna that has failed to adhere to a plastic substrate after exposure to salt mist and temperature/humidity (i.e., damp heat) testing.

FIG. 2 is a schematic describing a method of enhancing adhesion according to the teachings of the present disclosure.

FIG. 3A is a scanning electron microscopy (SEM) image of the silver nanoparticles in a silver nanoparticle film applied onto a polycarbonate substrate prior to annealing.

FIG. 3B is a scanning electron microscopy (SEM) image of the silver nanoparticles in a silver nanoparticle film applied onto a polycarbonate substrate after annealing at 120° C.

FIG. 3C is a scanning electron microscopy (SEM) image of the silver nanoparticles in a silver nanoparticle film applied onto a polycarbonate substrate after annealing at 180° C.

FIG. 4 is a plan view of a cross-cut area after tape adhesion testing of a comparative annealed silver nanoparticle ink applied to a polycarbonate substrate cleaned with isopropanol.

FIG. 5 is a plot of viscosity measured for a control ink and several inks modified according to the teachings of the present disclosure plotted as a function of shear rate.

FIG. 6 is a plan view of a cross-cut area after tape adhesion testing of an annealed silver nanoparticle film modified with an alkoxysilane applied to an alkoxysilane modified polycarbonate substrate according to the teachings of the present disclosure.

FIG. 7A is a plan view of a cross-cut area after tape adhesion testing of an annealed silver ink film with an alkoxysilane additive and an alkoxysilane primer layer on a polycarbonate surface.

FIG. 7B is a plan view of a cross-cut area after tape adhesion testing of an annealed silver ink film with the alkoxysilane additive and an alkoxysilane primer layer on a polycarbonate surface after humidity aging.

FIG. 8A is a perspective view of a silver nanoparticle ink printed on an alkoxysilane modified substrate after aging in a humidity chamber for 24 hours.

FIG. 8B is a perspective view of an alkoxysilane modified ink printed on an alkoxysilane modified substrate after aging in a humidity chamber for 240 hours.

### DETAILED DESCRIPTION

The following description is merely exemplary in nature and is not intended to limit the present disclosure, application, or uses. For example, the method made and used in accordance with the teachings contained herein is described throughout the present disclosure in conjunction with polycarbonate substrates commonly utilized in consumer electronic applications in order to more fully illustrate enhanced adhesion of silver nanoparticle inks and the use thereof. The incorporation and use of the disclosed method to enhance adhesion of silver nanoparticle inks on other plastic substrates for use in a variety of applications is contemplated to be within the scope of the present disclosure. It should be understood that throughout the description, corresponding reference numerals or letters indicate like or corresponding parts and features.

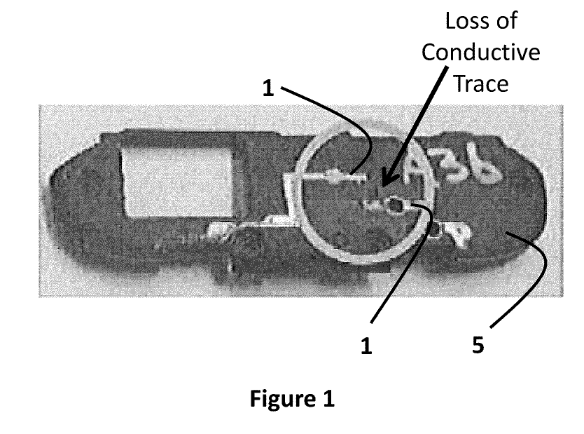

Printed silver nanoparticle inks show poor adhesion when applied to plastic substrates. As shown in FIG. 1, a portion of the printed conductive trace 1 formed from a silver nanoparticle ink is peeled off of a polycarbonate substrate 5 after temperature/humidity (Damp Heating) cycle or salt mist tests. Although conventional printed silver nanoparticle films have poor adhesion on polycarbonate substrates, adhesion of the films can be enhanced via substrate surface modification that involves the use of a primer layer as described herein.

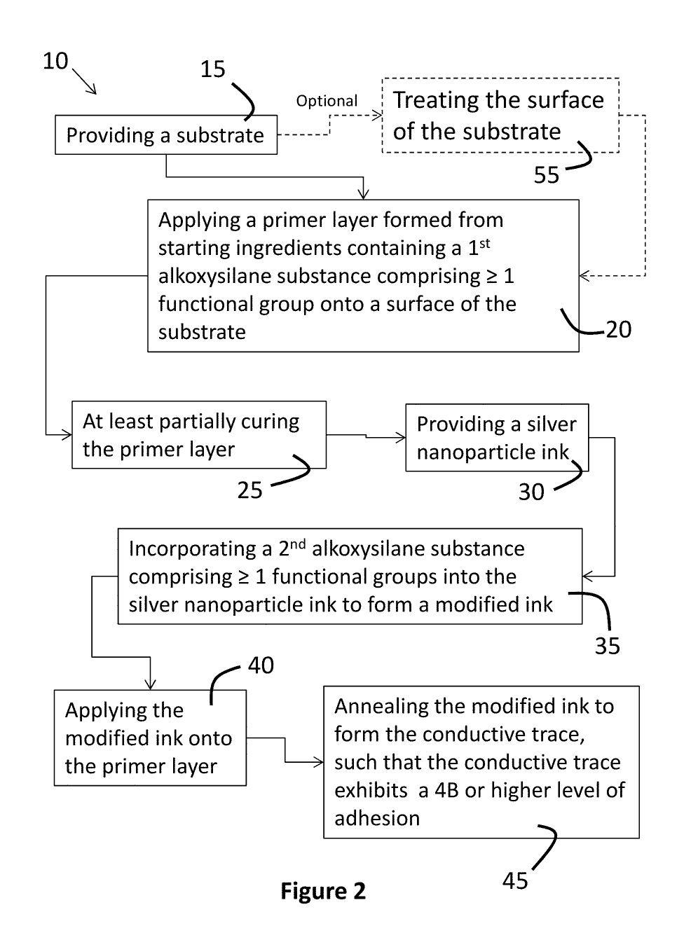

Referring now to FIG. 2, the method 10 of the present disclosure generally provides enhancement of adhesion of silver nanoparticle inks onto plastic substrates, such as polycarbonate, among others, at a low sintering temperature without any loss in the high conductivity of the annealed inks. The method 10 comprises, consists of, or consists essentially of providing 15 the substrate; applying 20 a primer layer onto a surface of the substrate, wherein the primer layer is formed from starting ingredients containing a first alkoxysilane substance comprising one or more functional groups; at least partially curing 25 the primer layer; providing 30 a silver nanoparticle ink; incorporating 35 a second alkoxysilane substance comprising one or more functional groups into the silver nanoparticle ink to form a modified ink; applying 40 the modified ink onto the primer layer; and annealing 45 the modified ink to form the conductive trace, such that the conductive trace exhibits a 4B or higher level of adhesion. Alternatively, the conductive trace exhibits a 5B level of adhesion as determined in a cross-hatch adhesion test. The conductive trace may also exhibit a peel strength greater than 1.5×10² N/m, alternatively greater than 2.0×10² N/m, or alternatively greater than 2.5×10² N/m, according to the FTM-2 90 degree peel test method (FINAT, Federation INtemationale des fabricants et transformateurs d'Adhésifs et Thermocollants sur papiers et autres). According to one aspect of the present disclosure, the first alkoxysilane is the same as the second alkoxysilane; according to another aspect of the present disclosure, the first alkoxysilane is different from the second alkoxysilane. For the purpose of this disclosure, the term of “conductive trace” refers to any conductive elements in any suitable shapes such as a dot, a pad, a line, a layer, and the like.

The mechanism through which a silver nanoparticle film adheres to a plastic substrate has been attributed to van der Waals forces between the particles and the substrate's surface. Referring once again to FIG. 2, based on this mechanism the adhesion may be improved by performing various physical treatments 55 of the surface of the substrate, including, but not limited to, an atmospheric/air plasma, a flame, an atmospheric chemical plasma, a vacuum chemical plasma, UV, UV-ozone, heat treatment, solvent treatment, mechanical treatment such as roughening the surface with sandpaper, abrasive blasting, water jet, and the like, or a corona discharging process prior to the application of the primer layer.

The cross-hatch adhesion rating for annealed silver nanoparticle ink films applied directly to a polycarbonate substrate after exposure to different physical treatments is provided in Table 1. The films were annealed at 120° C. for 60 minutes prior to evaluation with a crosscut and tape peel adhesion test. Unfortunately, simple physical treatments are not sufficient to improve the adhesion to a desired level. This is believed to be due to the particles being water-dispersible and the desired processing temperature of 120° C. is too low to cause the particles to fuse together. In the present disclosure, the first and second alkoxysilanes are believed to “connect” the loosely packed particles together and to also chemically bind the particles to the substrate's surface in order to achieve good adhesion of the silver nanoparticle ink film to a plastic substrate.

TABLE 1
Adhesion Rating of Silver Nanoparticle Films Coated on a Polycarbonate
Substrate After Different Physical Treatments.

| | Physical Treatment | Adhesion |
|---|---|---|
| Run No. | Method | Rating |
| 1 | None | 0B |
| 2 | Nitrogen Plasma | 1B-2B |
| 3 | Air Plasma, 2 scans | 1B-2B |
| 4 | Air Plasma, 8 scans | 1B-2B |
| 5 | Oxygen Plasma | 1B-3B |
| 6 | Corona | 0B-1B |

According to another aspect of the present disclosure, the silver nanoparticles may be fused together upon annealing at the desired temperature. Alternatively, the silver nanoparticles are not properly sintered together, especially at the interface region, at the predetermined annealing temperature, which is determined according to the properties of the substrate or other layers that are pre-deposited on to the substrate. According to some aspects of the present disclosure, a majority of the silver nanoparticles are not fused together upon annealing. Specifically, the average particle size of the silver nanoparticles in the conductive trace after annealing is substantially the same as that in the silver nanoparticle ink. According to other aspects of the present disclosure, a minority of the silver nanoparticles are not fused together upon annealing. In specific embodiments, at least 5 wt. %, alternatively at least 10 wt. %, or alternatively at least 40 wt. % silver nanoparticles are not fused together. The weight percentage can be measured by extracting the annealed silver nanoparticle conductive layer with a solvent that is compatible with the nanoparticles and calculating the weight loss.

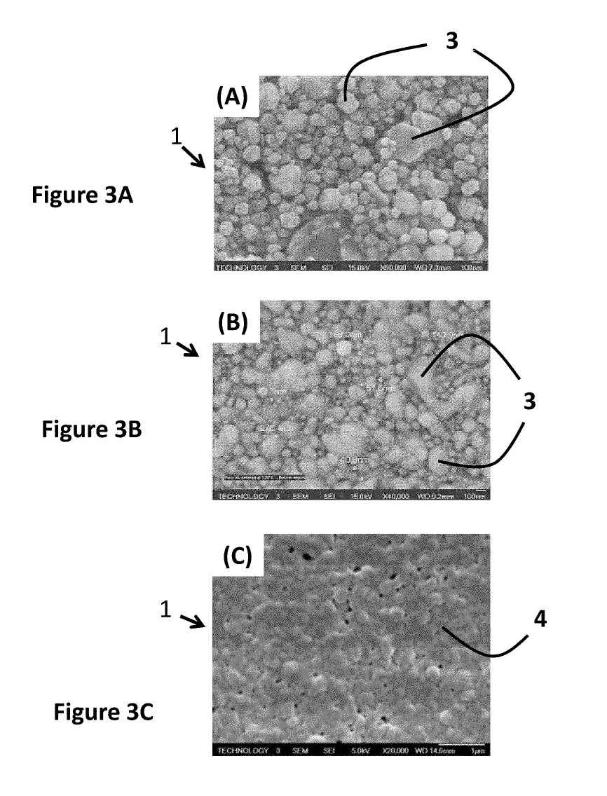

Referring to FIGS. 3A and 3B, optical images of silver nanoparticle films 1 before and after annealing at 120° C. for 60 min, respectively, are provided as obtained by scanning electron microscopy (SEM). In FIG. 3C an SEM image of a silver nanoparticle film 1 annealed at 180° C. is provided, which is above the desired limit for many plastic substrates. Each of the films 1, which have a thickness of about 5-8 micrometers (μm), is coated on a polycarbonate substrate using a doctor blade having a 0.0508 mm (2-mil) gap. The silver nanoparticles 3 in the silver nanoparticle film 1 range in size between about 40 nanometers (nm) to about 300 nm before annealing (see FIG. 3A). In FIG. 3C, the particles are shown to fuse together 4 when annealed at a temperature of 180° C. However, the predetermined temperature to reduce or eliminate degradation and/or deformation of the polycarbonate substrate is 120° C. After annealing at 120° C. (see FIG. 3B), a large amount of silver nanoparticles 3 have distinct boundaries, thereby, demonstrating that a particle size between about 40 nm to about 300 nm still exists at the interface region. Thus after annealing at 120° C., the silver nanoparticles 3 in the film 1 are not properly sintered by exposure to such a low sintering or annealing temperature.

Without wanting to be limited to theory, it is believed that the functionalized alkoxysilane agent will bond to the surface of the silver nanoparticles with a functional group, such as the amino group, while the alkoxy group will react with the primer layer, thereby, providing good adhesion. This bonding is particularly useful for silver nanoparticles that are not annealed properly due to the low annealing temperature predetermined by the substrate material. The presence of the primer layer generated from the alkoxysilane changes the dispersive adhesion, which is mainly attributed to van der Waals forces based on particle adhesion mechanisms, into chemical bonding.

The alkoxysilane having a functional group is used as the additive in the silver nanoparticle ink, and as an adhesion promoter (or primer layer) on the surface of the substrates. The combination of this functionalized silane agent both in the ink and on the substrate surface provides the silver nanoparticle films with excellent adhesion to a plastic substrate after annealing at the desired temperature.

The method according to this disclosure provides the benefits of (i) enhancing the adhesion of silver nanoparticle inks to plastic substrates from the 0B-3B level up to a 4B or 5B level; (ii) reducing the occurrence of adhesion being degraded after aging the films in a humidity chamber with 90% relative humidity at a temperature of 60° C. for 7 days or more; and (iii) reducing the occurrence of any color change in the silver nanoparticle films upon aging.

One specific example of a functionalized alkoxysilane, among many examples, used to enhance adhesion of an alcohol based silver nanoparticle ink on to a polycarbonate substrate is 3-aminopropyltriethoxysilane (γ-APS). One skilled in the art will understand that other alkoxysilanes may be utilized without exceeding the scope of the present disclosure. To modify the polycarbonate surface, γ-APS is hydrolyzed into a pre-polymer in ethanol and spin coated on the substrate, which yields a primer layer after curing at 120° C. for 10 minutes that has a thickness of about 210 nanometers (nm). The use of γ-APS as the surface primer only is not sufficient to promote the adhesion of the silver nanoparticle ink to a desired level. Rather a small amount γ-APS is also added into the silver nanoparticle ink (referred as “the modified silver nanoparticle ink”), to function as a “glue” to connect the particles and to attach the particles to the modified substrate.

The addition of the γ-APS into the silver nanoparticle ink has no effect on the viscosity or the color of the conductive ink. In other words, the modified silver nanoparticle ink has substantially the same viscosity as provided by the unmodified or original silver nanoparticle ink. Moreover, the film with the γ-APS additive retains low resistivity. The amino group is capable of being grafted to the surface of a silver nanoparticle. Upon hydrolyzing the ethoxy groups, the γ-APS can form a cross-linked network. Therefore, the γ-APS is able to chemically connect the incompletely fused silver nanoparticles in the film.

The adhesion of a γ-APS modified ink coated on a γ-APS modified plastic substrate provides for adhesion ratings on the order of 4B or 5B. The annealed films can be further aged in a high humidity chamber at a relative humidity (RH) of 90% RH and a temperature at 60° C. for over 10 days with no degradation of the adhesion being observed. In addition, these films retain their original metallic color after humidity aging. In contrast, the silver nanoparticle films without the alkoxysilane additive change color from silver to yellow during humidity aging. The use of the alkoxysilane additive makes the annealed silver nanoparticle film more moisture resistant.

Examples of functionalized silanes that are suitable alkoxysilanes with amino functional groups, include, but are not limited to, 2-aminoethyltrimethoxysilane, 2-aminoethyltriethoxysilane, 2-aminoethyltributoxy-silane, 2-aminoethyltripropoxysilane, 2-aminoethyltrimethoxysilane, 2-amino-ethyltriethoxysilane, 2-aminomethyltriethoxysilane, 3-aminopropyltrimethoxy-silane, 3-aminopropyltriethoxysilane, 3-aminopropyltributoxysilane, 3-amino-propyltripropoxysilane, 2-aminopropyltrimethoxysilane, 2-aminopropyltriethoxy-silane, 2-aminopropyltripropoxysilane, 2aminopropyltributoxysilane, 1-amino-propyltrimethoxysilane, 1-aminopropyltriethoxysilane, 1-aminopropyltributoxy-silane, 1-aminopropyltripropoxysilane, N-aminomethylamino ethyltrimethoxy-silane, N-aminomethylaminomethyltripropoxysilane, N-aminomethyl-2-amino-ethyltrimethoxysilane, N-aminomethyl-2-aminoethyltriethoxysilane, N-aminoethyl-2-aminoethyltripropoxysilane, N-aminomethyl-3-aminopropyltrimethoxysilane, N-aminomethyl-3-aminopropyltriethoxysilane, N-aminomethyl-3-aminopropyltripro-poxysilane, N-aminomethyl-2-aminopropyltriethoxysilane, N-aminomethyl-2-aminopropyltripropoxysilane, N-aminopropyltripropoxysilane, N-aminopropyl-trimethoxysilane, N-(2-aminoethyl)-2-aminoethyltrimethoxysilane, N-(2-amino-ethyl)-2-aminoethyltriethoxysilane, N-(2-aminoethyl)-2aminoethyltripropoxysilane, N-(2-aminoethyl)-aminoethyltriethoxysilane, N-(2-aminoethyl)aminoethyltripro-poxysilane,N-(2-aminoethyl)-2-aminopropyltrimethoxysilane, and the like.

Examples of functionalized silane that are suitable for use as alkoxysilanes having epoxy functionalities, include, but are not limited to, 3-glycidoxymethyltrimethoxysilane, 3-glycidoxymethyltriethoxysilane, 3-glycidoxy-methyltripropoxysilane, 3-glycidoxymethyltributoxysilane, 2-glycidoxyethyltri-methoxysilane, 2-glycidoxyethyltriethoxysilane, 2-glycidoxyethyltripropoxysilane, 2-glycidoxyethyltributoxysilane, glycidoxyethyltriethoxysilane, glycidoxyethyl-tripropoxysilane, glycidoxyethyltributoxysilane, 3-glycidoxypropyItrimethoxy-silane, 3-glycidoxypropyltriethoxysilane, 3-glycidoxypropyltripropoxysilane, 3-gly-cidoxy-propyltributoxysilane, 2-glycidoxypropyltrimethoxysilane, 2-glycidoxy-propyl-triethoxysilane, 2-glycidoxypropyltripropoxysilane, 2-glycidoxypropyl-tributoxysilane, 1-glycidoxypropyltriethoxysilane, 1-glycidoxypropyltrimethoxy-silane, 1-glycidoxypropyltripropoxysilane, and the like.

In addition, other alkoxysilanes with functional groups such as acrylate, methacrylate, mercapto, and vinyl groups can be used without exceeding the scope of the present disclosure. The concentration of the functionalized alkoxysilane added into the silver nanoparticle ink can be for example from about 0.01 wt. % to about 2.0 wt. %; alternatively, from about 0.1 wt. % to about 1.0 wt. %; alternatively, from about 0.3 wt. % to about 0.7 wt. % of the total amount silver in the ink.

When used as the primer layer on the substrate's surface, the functionalized alkoxysilanes may be hydrolyzed as a polymer prior to use. The primer layer can be applied to the surface of the substrate using any suitable method including, spin coating, dip coating, spray coating, printing, or the like. After application, the primer layer can be cured at a temperature between about 60° C. to about 150° C.; alternatively, from about 80° C. to about 120° C.; or alternatively from about 100° C. to about 120° C. for a period of time ranging between about 2 minutes to about 60 minutes; alternatively, from about 5 minutes to about 10 minutes.

The thickness of the resulting primer layer ranges from about 50 nanometers (nm) to about 1 micrometer (μm); alternatively, from about 100 nm to about 500 nm; alternatively, from about 100 nm to about 300 nm. The thickness of the annealed primer layer may be equal to or greater than the average roughness (Ra) of the substrate's surface. When desirable, the primer layer may also function as a planarization layer. The average roughness (Ra) represents the arithmetic average of the absolute values of the roughness profile measured by scanning the substrate's surface using any known contact or non-contact profilometry method over a scan length of about 1 mm or more. Contact profilometry methods may include, without limitation, any type of mechanical profilometer that utilizes a contacting stylus. Non-Contact profilometry methods, may include but are not limited to, phase shifting interferometry, coherence scanning interferometry, confocal microscopy, scanning tunneling microscopy, and atomic force microscopy.

The modified silver nanoparticle ink may be applied onto the at least partially cured primer layer using an analog or a digital printing method. The ability to apply the silver nanoparticle ink to a plastic substrate using an additive printing technique offers several advantages, such as fast turn-around time and quick prototyping capability, easy modification of device designs, and potentially lower-manufacturing costs due to reducing material usage and the number of manufacturing steps. The direct printing of conductive inks also enables the use of thinner substrates when forming light-weight devices. Additive printing may also be a more environmentally friendly approach due to the reduced chemical waste generated in the device manufacturing process, when compared to conventional electroplating or electroless plating processes.

In general, printing technologies can be divided into two major categories, namely, analog printing and digital printing. Several examples of analog printing include, without limitation, flexographic, gravure, and screen printing. Several examples of digital printing include, but are not limited to, inkjet, aerosol jet, disperse jet, and drop-on-demand techniques. While analog printing offers high printing speed, digital printing enables the facile change of printed pattern designs, which may find use in the field of personalized electronics. Among the digital printing technologies, aerosol jet and disperse jet are attractive due to their large distance between the nozzle and the substrate surface. This characteristic allows conformal deposition of conductive inks on substrates that exhibit a topographic structure. When integrated with a 5-axis motion-control stage or robotic arm, aerosol jet and dispense jet can be used to print conductive elements onto 3-D surfaces. The silver nanoparticle ink may have a viscosity that is predetermined by the application process, for example from a few millipascal-seconds (mPa-sec) or centipoise (cps) to about 20 mPa-sec for an inkjet printing process, or from about 50 mPa-sec to about 1000 mPa-sec for aerosol jet, flexographic, or gravure printing processes, or above 10,000 mPa-sec for a screen printing process. Alternatively, the silver nanoparticle conductive trace can be printed onto 3-D surfaces using aerosol jet and/or dispense jet printing techniques.

The silver nanoparticles in the silver nanoparticle ink have a particle size that is between about 2 nm and about 800 nm; alternatively, from about 10 nm to about 300 nm. The silver nanoparticles may alternatively have a particle size that is within the range of about 50 nm to about 300 nm. When desirable, the silver nanoparticles may also have organic stabilizers attached to the surface, which prevent the aggregation of the silver nanoparticles and help dispersion of the nanoparticles in suitable solvents. According to one aspect of the present disclosure, the silver nanoparticles may have a hydrophilic coating on the surface. In this case, the silver nanoparticles are dispersible in a polar solvent such as acetate, ketone, alcohol, or even water

According to another aspect of the present disclosure, the silver nanoparticles may be fused together upon annealing at the desired temperature that has no adverse effect on the substrate or the pre-deposited layer. In The silver nanoparticle ink may be annealed at a temperature no more than 150° C., including no more than 120° C., or no more than 80° C. Alternatively, the silver nanoparticles are not properly sintered together, especially at the interface region, at the predetermined annealing temperature, which is determined according to the properties of the substrate or other layers that are pre-deposited on to the substrate. In this case, the average particle diameter of the silver nanoparticles in the conductive trace after annealing is substantially the same as that in the silver nanoparticle ink, which is referred as an incompletely fused silver nanoparticle conductive layer. The functionalized alkoxysilanes will bond to the surface of the silver nanoparticles with the functional groups, while the hydrolysable alkoxy groups will react with the functional groups in the primer layer for a good adhesion.

After annealing, resistivity of the annealed silver nanoparticle conductive trace can be measured using a 4-point probe method according to ASTM-F1529. According to another aspect of the present disclosure, the conductive trace has a resistivity less than 1.0×10⁴ ohms-cm; alternatively less than 5.0×10⁻⁵ ohms-cm; or alternatively less than 1.0×10⁻⁵ ohms-cm. The ability to achieve low resistivity and good adhesion upon annealing at a low temperature is desirable for many applications. The thickness of the annealed silver nanoparticle conductive trace can be for example from about 100 nm to about 50 micrometers or microns, alternatively, from about 100 nm to about 20 microns, or alternatively, from about 1 micron to about 10 microns, depending on the methods used to apply the ink and the applications in which the conductive trace is utilized.

The plastic substrate may be a polycarbonate, an acrylonitrile butadiene styrene (ABS), a polyamide, a polyester, a polyimide, vinyl polymer, polystyrene, polyether ether ketone (PEEK), polyurethane, epoxy-based polymer, polyethylene ether, polyether imide (PEI), polyolefin, a polyvinylidene fluoride (PVDF), or a copolymer thereof. A specific example of a polyether imide and a polycarbonate substrate is Ultem™ (SABIC Innovative Plastics, Massachusetts) and Lexan™ (SABIC Innovative Plastics, Massachusetts), respectively. Alternatively, the substrate is a polycarbonate substrate.

According to another aspect of the present disclosure, a functional conductive layered composite may comprise the conductive trace formed according to the teachings described above and further defined herein. For the purpose of this disclosure, the term “functional conductive layered composite” refers to any component, part, or composite structure that incorporates the conductive trace. The functional conductive layered composite may function as an antenna, an electrode of an electronic device, or an interconnect joining two electronic components.

The method of forming a functional conductive layered composite comprises providing a plastic substrate; applying a primer layer to a surface of the plastic substrate; the primer layer is formed from starting ingredients containing a first alkoxysilane substance comprising one or more functional groups; at least partially curing the primer layer at a temperature no more than 120° C., such that the at least partially cured primer layer exhibits an average thickness that is equal to or greater than an average roughness (Ra) value measured for the surface of the substrate; providing a silver nanoparticle ink; incorporating a second alkoxysilane substance comprising one or more functional groups into the silver nanoparticle ink to form a modified ink in a concentration between about 0.01 wt. % and about 2.0 wt. % based on the total weight of silver in the silver nanoparticle ink; applying the modified ink onto the primer layer using an analog or a digital printing process; annealing the modified ink at a temperature no more than 120° C. to form the conductive trace, such that the conductive trace exhibits a 5B level of adhesion; and incorporating the conductive trace into the functional conductive layered composite. The conductive trace may exhibit 5B adhesion after exposure for at least 4 days to a high humidity environment with 90% relative humidity and a temperature of 60° C.

The substrate used in the layered composite may be a polycarbonate, an acrylonitrile butadiene styrene (ABS), a polyamide, a polyester, a polyimide, vinyl polymer, polystyrene, polyether ether ketone (PEEK), polyurethane, epoxy-based polymer, polyethylene ether, polyether imide (PEI), polyolefin, or a polyvinylidene fluoride (PVDF) substrate. The one or more functional groups in the first and second alkoxysilane may be amino groups, epoxy groups, acrylate groups, methacrylate groups, mercapto groups, vinyl groups, or a mixture thereof. In addition, the silver nanoparticle ink may comprise silver nanoparticles having an average particle diameter in the range of about 2 nanometers to about 800 nanometers. The average particle diameter of the silver nanoparticles in the conductive trace after annealing is substantially the same as that in the silver nanoparticle ink.

Within this specification, embodiments have been described in a way which enables a clear and concise specification to be written, but it in intended and will be appreciated that embodiments may be variously combined or separated without parting from the invention. For example, it will be appreciated that all preferred features described herein are applicable to all aspects of the invention described herein.

The following specific examples are given to further illustrate the preparation and testing of the adhesion of silver nanoparticle films to plastic substrates according to the teachings of the present disclosure and should not be construed to limit the scope of the disclosure. Those skilled-in-the-art, in light of the present disclosure, will appreciate that many changes can be made in the specific embodiments which are disclosed herein and still obtain alike or similar result without departing from or exceeding the spirit or scope of the disclosure.

A commercially available silver nanoparticle ink, namely, PG-007 (Pam Co. Ltd., South Korea) is used throughout the following examples. This silver nanoparticle ink comprises about 60 wt. % silver dispersed in mixed solvents of 1-methoxy-2-propanol (MOP) and ethylene glycol (EG). The silver nanoparticles have a particle size that is within the range of about 50 nm to about 300 nm with an overall average size between about 80-100 nm. The substrate in the examples is a Lexan™ 141R polycarbonate substrate (SABIC Innovative Plastics, Massachusetts).

The adhesion of the annealed or sintered films that are formed from the silver nanoparticle inks applied to a plastic substrate is tested according to ASTM D3359-09 (ASTM International, West Conshohocken, Pa.). The silver films are crosscut into 100 pieces of 1×1 mm squares. Then, Scotch™ tape 600 (The 3M Company, St. Paul, Minn.) is applied on top of the crosscut area, and gently rubbed to make a good contact between the tape and the silver nanoparticle films. After 1.5 minutes, the tape is peeled off back-to-back to examine how much silver film is removed from the substrate. Based on the amount of silver film that is removed, the adhesion is rated from 0B to 5B with 0B being the worst and 5B the best.

### Example 1—Control

Polycarbonate substrates were cleaned with isopropanol (IPA) and dried with compressed air. Some of the substrates were further treated with air plasma to improve the adhesion. The silver nanoparticle ink PG-007 (Paru Co. Ltd, South Korea) was applied on top of the substrate with a PA5363 applicator (BYK Gardner GmbH, Germany) having a 0.0508 mm (2-mil) gap. The wet films were dried at room temperature for about 10 minutes, then completely dried and annealed in a thermal oven at 120° C. for 60 minutes. It should be noted that this low annealing temperature of 120° C. is determined by the properties exhibited by the low-cost and temperature-sensitive polycarbonate substrate.

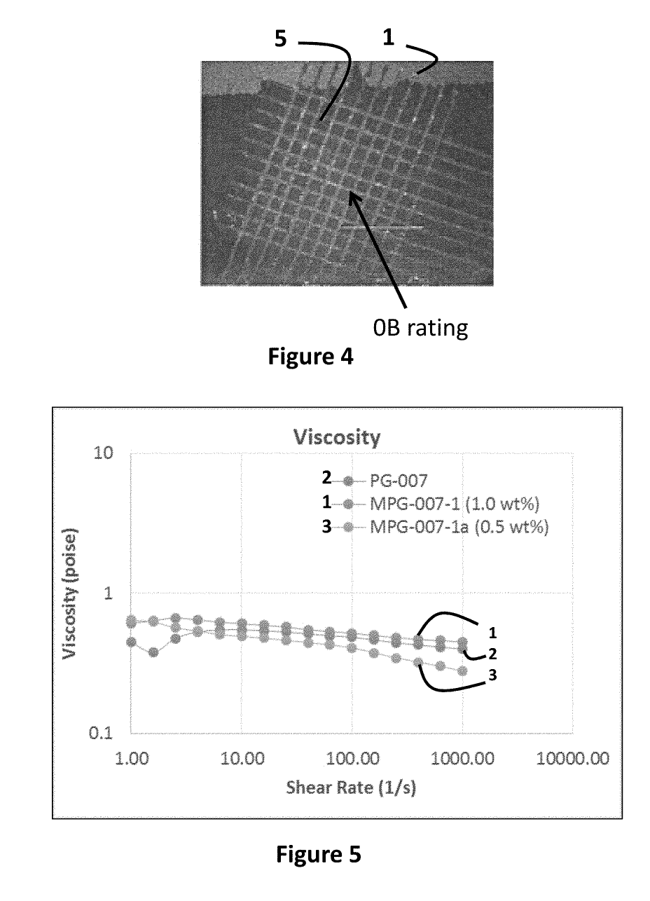

FIG. 4 shows the result of the adhesion test for the annealed PG-007 ink 1 on a plain polycarbonate substrate 5. The crosscut area was completely removed by the tape (0B rating), indicating very poor adhesion of the silver nanoparticle ink 1 to the polycarbonate substrate 5 upon annealing at 120° C. This annealed silver nanoparticle film 1 was freshly prepared and not subjected to any harsh environment tests such as high humidity or salt mist. These harsh environment tests will usually cause further degradation of adhesion.

### Example 2—Control with γ-APS Modified Polycarbonate Substrate

In this Control Example, in lieu of the plain polycarbonate substrate, an alkoxysilane modified polycarbonate substrate was used. Preparation of a 3-aminopropyltriethoxysilane (γ-APS) primer solution included adding a total of 4.41 grams of 3-aminopropyltriethoxysilane into 38.61 grams of ethanol, followed by the further addition of 1.08 grams distilled water. The mixture was stirred at room temperature for 48 hours in order to hydrolyze the γ-APS to form a pre-polymer for substrate modification.

The polycarbonate substrate was cleaned with isopropanol (IPA) and dried with compressed air. Above γ-APS primer solution was then spin coated onto the polycarbonate substrate at 1000 rpm for 60 seconds, followed by curing in an oven at 120° C. for 10 minutes to yield a primer layer having a thickness of about 210 nm as measured with a surface profilometer. After the primer layer is cured, the silver nanoparticle ink (PG-007, Paru Co. Ltd, South Korea) was coated on top of the primer layer in the same way as discussed for the Controls in Example 1.

After annealing the silver nanoparticle films at 120° C. for 60 minutes, the adhesion of the silver nanoparticle films was evaluated according to ASTM D3359-09. Poor adhesion on the level of 0B-1B was observed, thereby, indicating that the use of γ-APS primer layer alone is not sufficient to improve the adhesion.

### Example 3—Control

In this Example, in lieu of the commercial silver nanoparticle ink, a modified silver nanoparticle ink was used on a plain polycarbonate substrate. A commercially available silver nanoparticle ink (PG-007 ink, Pam Co. Ltd., South Korea) was modified by the addition of 0.5 wt. % to 1.0 wt. % of γ-APS additive to form a modified ink (MPG-007-1). More specifically, a total 7 grams of the commercial PG-007 ink was added into a glass bottle, followed by the slow addition of 21.3 milligrams to 42.6 milligrams γ-APS. The amount of γ-APS was calculated to be 0.5 wt. % to 1.0 wt. % of the total silver in the ink. The ink was shear mixed for 2 minutes at room temperature prior to use. A comparison of the rheological behavior exhibited by the modified ink and the original ink is provided in FIG. 5. The ink with 0.5 or 1.0 wt. % γ-APS additive exhibits similar rheological behavior as the original ink over a wide range of shear rate. Since adding a small amount of γ-APS had no or little effect on the rheological behavior of the ink, it is expected that this additive will have a minimum impact on printing.

The modified silver nanoparticle ink (MPG-007-1) was coated on a plain polycarbonate substrate and annealed in the same manner as shown in Control Example 1. After annealing, adhesion was assessed using the crosscut and tape peel method. Similar to the other controls, a poor adhesion of 0B was observed, indicating that the use of γ-APS additive in the ink only is not sufficient to enhance the adhesion.

### Example 4—γ-APS Modified Ink and γ-APS Modified Substrate

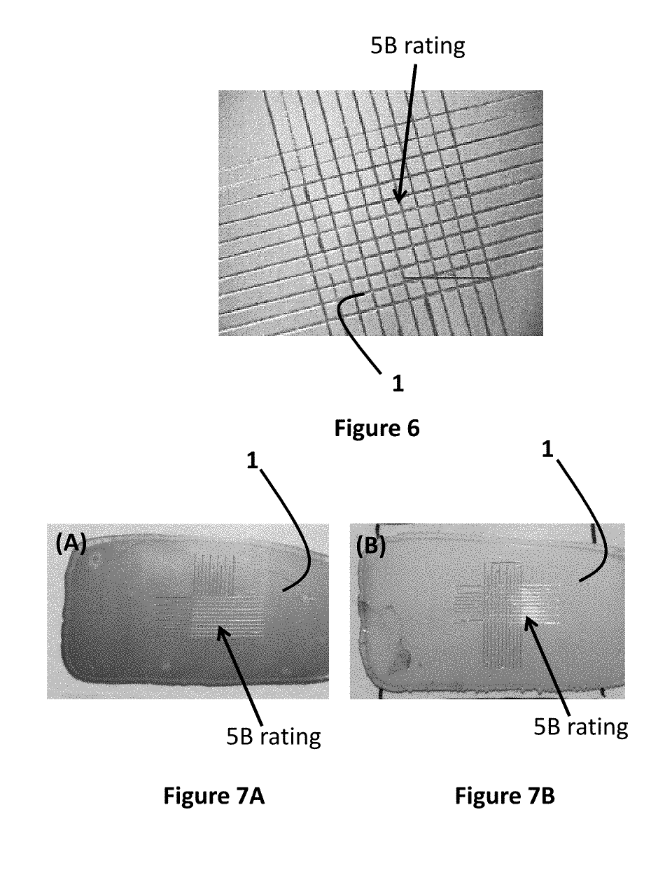

In this Example, the modified ink (MPG-007-1a) of Example 3 was coated onto a γ-APS modified polycarbonate substrate. After being dried and annealed in the same manner as described in Example 1, the adhesion level was evaluated using the crosscut and peel test. As shown in FIG. 6, none or little of the annealed silver nanoparticle film 1 was removed from the substrate, indicating an excellent adhesion rating of 4B or higher.

### Example 5—Humidity Environment Testing

In this Example, the modified ink (MPG-007-1) of Example 3 was coated onto a modified γ-APS modified polycarbonate substrate. After being dried and annealed in the same manner as described in Example 1, the adhesion level was evaluated using the crosscut and peel test. As shown in FIG. 7A, none of the annealed silver nanoparticle film 1 was removed from the substrate, indicating an adhesion level of 5B for the fresh sample.

The sample was then further aged in a high humidity chamber at a relative humidity (RH) of 90% and a temperature of 60° C. for 4 days and the adhesion reexamined. As shown in FIG. 7B, no degradation of adhesion was observed after the humidity aging. Moreover, in contrast to the silver nanoparticle film without the γ-APS additive that changed color from silver to yellow during the humidity aging, the film with the γ-APS additive retained the same color after the humidity aging. Thus the silver nanoparticle film with the γ-APS additive is more resistant to moisture.

### Example 6—Conductive Traces Formed from Silver Nanoparticle Inks

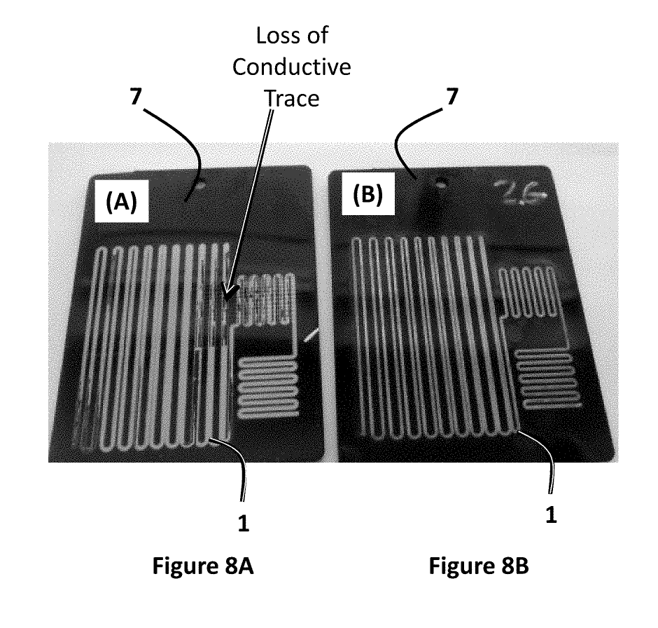

Referring now to FIGS. 8A and 8B, conductive lines 1 were printed onto a γ-APS modified substrate 7. Good uniformity of the printed lines 1 was observed. Similar to the control sample of Example 2, a commercially available silver nanoparticle ink (PG-007, Pam Co. Ltd., South Korea) was printed on the substrate and annealed to form a conductive trace. Upon exposure of the conductive trace 1 to aging in humidity chamber at 90% RH and a temperature of 60° C. for 24 hours, both a color change and poor adhesion to the γ-APS modified substrate 7 was observed (see FIG. 7A). In comparison, the γ-APS modified silver nanoparticle ink (MPG-007-1a) printed on a γ-APS modified substrate 7 and annealed according to Example 1 showed excellent adhesion of the annealed film 1 to the γ-APS modified substrate 7 and retained the same silver color after aging in the humidity chamber for 240 hours (see FIG. 7B).

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of forming a conductive trace on a substrate, the method comprising:
providing the substrate;
applying a primer layer onto a surface of the substrate, wherein the primer layer is formed from starting ingredients containing a first alkoxysilane substance comprising one or more functional groups;
at least partially curing the primer layer;
providing a silver nanoparticle ink;
incorporating a second alkoxysilane substance comprising one or more functional groups into the silver nanoparticle ink to form a modified ink;
applying the modified ink onto the primer layer; and
annealing the modified ink to form the conductive trace;
wherein the conductive trace exhibits a 4B or higher level of adhesion.

2. The method of claim 1, where in the conductive trace exhibits a 5B level of adhesion.

3. The method according to claim 1, wherein each of the one or more functional groups of the alkoxysilane substance used to form the primer layer or incorporated into the silver nanoparticle ink is independently selected to be an amino, epoxy, acrylate, methacrylate, mercapto, or vinyl group.

4. The method according to claim 1, wherein the primer layer is applied to the substrate using a spin coating, a dip coating, a spray coating, a printing, or a flow coating technique, and the modified silver nanoparticle ink is applied onto the at least partially cured primer layer using an analog or a digital printing method.

5. The method according to claim 1, wherein the primer layer is at least partially cured at a temperature no more than 120° C. for a period of time ranging between about 2 minutes to about 60 minutes.

6. The method according to claim 1, wherein the alkoxysilane substance is incorporated into the silver nanoparticle ink in a concentration from about 0.01 wt. % to about 2.0 wt. % based on the total weight of silver in the silver nanoparticle ink.

7. The method according to claim 1, wherein the at least partially cured primer layer exhibits an average thickness that is equal to or greater than an average roughness (Ra) value measured for the surface of the substrate.

8. The method according to claim 1, wherein the at least partially cured primer layer exhibits an average thickness that is from about 50 nanometers to about 1 micrometer;

9. The method according to claim 1, wherein the method further comprises treating the surface of the substrate using an atmospheric/air plasma, a flame, an atmospheric chemical plasma, a vacuum chemical plasma, UV, UV-ozone, heat treatment, solvent treatment, mechanical treatment, or a corona charging process prior to the application of the primer layer.

10. The method according to claim 1, wherein the conductive trace exhibits 5B adhesion after exposure for at least four days to a high humidity environment with 90% relative humidity and at 60° C.

11. The method according to claim 1, wherein the substrate is a plastic substrate formed from a polycarbonate, an acrylonitrile butadiene styrene (ABS), a polyamide, or a polyester, a polyimide, vinyl polymer, polystyrene, polyether ether ketone (PEEK), polyurethane, epoxy-based polymer, polyethylene ether, polyether imide (PEI), polyolefin, a polyvinylidene fluoride (PVDF), or a copolymer thereof.

12. The method according to claim 1, wherein the silver nanoparticle ink comprises silver nanoparticles having an average particle diameter in the range of about 2 nanometers to about 800 nanometers; optionally, one or more of the silver nanoparticles is at least partially encompassed with a hydrophilic coating.

13. The method according to claim 1, wherein the modified silver nanoparticle ink has substantially the same viscosity as the provided silver nanoparticle ink.

14. The method according to claim 1, wherein the conductive trace to the substrate exhibits a peel strength greater than 1.5×10² N/m.

15. The method according to claim 12, wherein the average particle diameter of the silver nanoparticles in the conductive trace after annealing is substantially the same as that in the silver nanoparticle ink.

16. A functional conductive layered composite comprising the conductive trace formed according to the method of claim 1.

17. The functional conductive layered composite according to claim 16, wherein the functional conductive layered composite functions as an antenna, an electrode of a sensor, or an interconnect between two electronic components.

18. A method of forming a functional conductive layered composite comprising:
providing a plastic substrate selected from the group consisting of a polycarbonate, an acrylonitrile butadiene styrene (ABS), a polyamide, a polyester, a polyimide, vinyl polymer, polystyrene, polyether ether ketone (PEEK), polyurethane, epoxy-based polymer, polyethylene ether, polyether imide (PEI), polyolefin, or a polyvinylidene fluoride (PVDF) substrate;
applying a primer layer to a surface of the plastic substrate; the primer layer is formed from starting ingredients containing a first alkoxysilane substance comprising one or more functional groups; the one or more functional groups being amino groups, epoxy groups, acrylate groups, methacrylate groups, mercapto groups, vinyl groups, or a mixture thereof;
at least partially curing the primer layer at a temperature no more than 120° C.; wherein the at least partially cured primer layer exhibits an average thickness that is equal to or greater than an average roughness (Ra) value measured for the surface of the substrate;
providing a silver nanoparticle ink; the silver nanoparticle ink comprising silver nanoparticles having an average particle diameter in the range of about 2 nanometers to about 800 nanometers;
incorporating a second alkoxysilane substance comprising one or more functional groups into the silver nanoparticle ink to form a modified ink in a concentration between about 0.01 wt. % to about 2.0 wt. % based on the total weight of silver in the silver nanoparticle ink; the one or more functional groups being amino groups, epoxy groups, acrylate groups, methacrylate groups, mercapto groups, vinyl groups, or a mixture thereof;
applying the modified ink onto the primer layer using an analog or a digital printing process;
annealing the modified ink at a temperature no more than 120° C. to form the conductive trace; wherein the conductive trace exhibits a 5B level of adhesion; and
incorporating the conductive trace into the functional conductive layered composite.

19. The method according to claim 18, wherein the conductive trace exhibits 5B adhesion after exposure for at least 4 days to a high humidity environment with 90% relative humidity and at 60° C.

20. The method according to claim 18, wherein the average particle diameter of the silver nanoparticles in the conductive trace after annealing is substantially the same as that in the silver nanoparticle ink.
